(19) United States
(12) Patent Application Publication
(10) Pub. No.: US 2026/0368005 A1
(43) Pub. Date: Nov. 19, 2026

(54) ON-DEVICE, LLM-BASED DEVICE CONTROL AND MANAGEMENT

(71) Applicant: YAHOO ASSETS LLC, New York, NY (US)

(72) Inventors: Mohit GOENKA, Santa Clara, CA (US); Ashish Khushal DHARAMSHI, Sunnyvale, CA (US); Gnanavel SHANMUGAM, San Jose, CA (US); Nikita VARMA, Milpitas, CA (US)

(21) Appl. No.: 19/209,148

(22) Filed: May 15, 2025

(51) Int. Cl. G06F 9/54

(52) U.S. Cl. CPC G06F 9/542

(57) ABSTRACT

Disclosed are systems and methods that provide a framework that leverages on-device artificial intelligence (AI), inclusive of machine learning (ML) and Large Language Models (LLMs), to provide user profiling capabilities directly on end-user devices. By leveraging on-device LLM technologies, the disclosed framework addresses critical technical challenges related to scalability, privacy, and adaptive learning that have limited previous personalization approaches. The framework enables improved personalization capabilities while maintaining strict privacy guarantees and minimizing infrastructure requirements.

### FIELD OF THE DISCLOSURE

The present disclosure relates to electronic management and control of digital resources, and more particularly, to a decision intelligence (DI)-based computerized framework for on-device profiling and digital resource control, management and rendering based therefrom.

### SUMMARY OF THE DISCLOSURE

According to some embodiments, the disclosed systems and methods provide a framework that leverages on-device (or “device-based,” used interchangeably) artificial intelligence (AI), inclusive of machine learning (ML) and Large Language Models (LLMs), to provide user profiling capabilities directly on end-user devices. This approach represents a significant paradigm shift from traditional AI deployment architectures. The conventional methodology involves training computerized models on high-performance server infrastructure using extensive datasets, followed by deployment to individual devices solely for inference operations. The instant disclosure provides advanced computerized mechanisms for implementations of on-device LLMs that fundamentally transform user profiling methodologies while addressing critical challenges related to scalability, privacy, and personalization.

In some embodiments, the framework addresses fundamental technical constraints inherent in conventional server-based training methodologies. The computational requirements for training distinct models for each individual user within a large-scale application ecosystem present prohibitive resource demands. The technical complexity escalates exponentially when considering applications with user bases in the millions, as each personalized model requires dedicated computational resources, storage allocation, and maintenance overhead on server infrastructure. This approach becomes technically unfeasible at scale due to both hardware limitations and economic constraints. Furthermore, the server-centric approach introduces substantial latency challenges, as inference operations require continuous communication between client devices and backend infrastructure. This dependency creates technical vulnerabilities related to network availability, bandwidth limitations, and server response times, potentially compromising the real-time responsiveness required for seamless user experiences.

To that end, among other technical advancements, according to some embodiments, the disclosed framework implements a technically advanced alternative through on-device LLM deployment. This architecture, as discussed herein, utilizes recent advancements in model compression and optimization techniques that enable deploying smaller yet functionally capable LLM variants, such as, for example, Gemini Nano directly on user devices. The technical architecture incorporates several key components: a model deployment layer that efficiently transfers the optimized LLM to the client device while minimizing bandwidth requirements; a runtime environment that executes the LLM within the constraints of mobile device computational resources; an inference optimization layer that maximizes performance while minimizing power consumption; a contextual data processing module that analyzes user interactions within the application environment; a preference extraction mechanism that identifies patterns and preferences from user behavior; and a recommendation generation component that produces personalized content suggestions.

In some embodiments, the technical implementation leverages hardware acceleration capabilities available on modern mobile devices, including neural processing units (NPUs) and graphics processing units (GPUs), to optimize computational efficiency. Advanced memory management techniques ensure that the framework maintains acceptable performance characteristics even on devices with limited RAM allocations.

In some embodiments, the framework delivers substantial technical advantages through its on-device architecture. By shifting computational workloads to the client device, the framework eliminates the need for continuous server communication during inference operations. This architectural decision results in measurable performance improvements, including reduced latency, decreased bandwidth consumption, and enhanced reliability in variable connectivity environments. The framework's technical design enables continuous learning capabilities, as the on-device LLM can adapt to evolving user behaviors in real-time without requiring server synchronization. This adaptive learning mechanism implements incremental model updates based on interaction patterns, gradually refining the accuracy of user profiles and subsequent recommendations. The technical implementation incorporates differential privacy techniques to ensure that these learning processes maintain appropriate privacy safeguards. Furthermore, the framework's architecture substantially reduces infrastructure requirements for application providers.

Thus, by distributing computational workloads across the user device ecosystem, the framework minimizes the need for extensive server resources traditionally required for personalization operations. The disclosed technical mechanisms, therefore, transform fixed infrastructure approaches into a more scalable model where computational resources scale naturally with the user base.

In some embodiments, the framework can incorporate privacy-preserving mechanisms through its on-device architecture. All sensitive user data, including interaction patterns, content preferences, and behavioral indicators, remains encapsulated within the local device environment. The technical implementation ensures that raw user data never leaves the device for processing purposes, significantly reducing potential exposure vectors. The framework implements a privacy-by-design approach where model inferences occur exclusively within the device's secure execution environment. When necessary for aggregate analytics or global model improvements, the framework can implement federated learning techniques, transmitting only anonymized gradient updates rather than raw user data. Such technical methodology ensures compliance with emerging privacy regulations while maintaining personalization capabilities. Additionally, the framework incorporates differential privacy techniques that mathematically guarantee user anonymity even when limited data must be transmitted for system improvements. These technical safeguards prevent potential re-identification attacks while preserving the utility of aggregated insights.

In some embodiments, the framework addresses scalability challenges through its distributed computational approach. Traditional personalization systems face exponential resource requirements as user bases expand, necessitating proportional increases in server infrastructure. The framework's technical design fundamentally restructures this relationship by leveraging the computational capabilities of end-user devices. The technical implementation enables linear scalability characteristics, as each new user contributes additional computational resources to the overall system rather than consuming shared server capacity. This architectural configuration enables application providers to scale personalization capabilities to millions or billions of users without corresponding infrastructure investments. The framework's technical design also incorporates efficient model distribution mechanisms, minimizing bandwidth requirements during initial deployment and subsequent updates. Incremental model update techniques ensure that only necessary components are transmitted during optimization cycles, further reducing scaling constraints.

In some embodiments, the framework implements advanced technical mechanisms for continuous adaptation to individual user preferences. In some embodiments, such on-device LLM analyzes interaction patterns, content engagement metrics, and explicit user selections to construct increasingly accurate user profiles. These profiles serve as contextual inputs for subsequent LLM operations, enabling increasingly refined personalization over time. The technical implementation incorporates reinforcement learning techniques that optimize recommendation quality based on user feedback signals, both explicit and implicit. This adaptive mechanism ensures that the framework's personalization capabilities continuously improve without requiring manual reconfiguration or external intervention. The framework also implements transfer learning capabilities, allowing the on-device model to leverage insights from specific usage domains to improve performance in related but distinct application contexts. This cross-domain knowledge transfer enhances personalization efficiency without requiring separate training processes for each application function.

In some embodiments, the framework incorporates technical safeguards against potential biases in personalization outcomes. The on-device LLM implementation includes algorithmic fairness mechanisms that monitor recommendation distributions and adjust outputs to prevent reinforcement of existing biases. These technical components ensure that personalization does not inadvertently create filter bubbles or echo chambers that limit user exposure to diverse content. The framework's design includes diversity promotion algorithms that intentionally incorporate varied recommendations while maintaining overall relevance to user preferences. This balanced approach maximizes user satisfaction while preventing potential negative consequences of over-personalization.

In some embodiments, the framework implements advanced resource management techniques to optimize performance across diverse device capabilities. Such technical mechanisms incorporate adaptive computational scheduling that adjusts processing intensity based on available device resources, battery status, and current usage patterns. This dynamic resource allocation ensures acceptable performance across the full spectrum of supported devices while preventing excessive power consumption or thermal issues. The framework also implements tiered functionality that gracefully degrades personalization complexity on devices with limited capabilities, ensuring universal accessibility while maximizing capabilities on high-performance devices. Such technical approach enables consistent user experiences across heterogeneous device ecosystems.

Accordingly, as discussed herein, the disclosed systems and methods provide a framework that represents a significant technical advancement in personalization capabilities for mobile and edge devices. By leveraging on-device LLM technologies, the framework addresses critical challenges related to scalability, privacy, and adaptive learning that have limited previous personalization approaches. The framework enables unprecedented personalization capabilities while maintaining strict privacy guarantees and minimizing infrastructure requirements.

According to some embodiments, a method is disclosed for a DI-based computerized framework for on-device profiling and digital resource control, management and rendering based therefrom. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for on-device profiling and digital resource control, management and rendering based therefrom.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter can be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms can have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology can be understood at least in part from usage in context. For example, terms, such as “and”, “or”, or “and/or,” as used herein can include a variety of meanings that can depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, can be used to describe any feature, structure, or characteristic in a singular sense or can be used to describe combinations of features, structures or characteristics in a plural sense. Similarly, terms, such as “a,” “an,” or “the,” again, can be understood to convey a singular usage or to convey a plural usage, depending at least in part upon context. In addition, the term “based on” can be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium can include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that can couple devices so that communications can be exchanged, such as between a server and a client device or other types of devices, including between wireless devices coupled via a wireless network, for example. A network can also include mass storage, such as network attached storage (NAS), a storage area network (SAN), a content delivery network (CDN) or other forms of computer or machine-readable media, for example. A network can include the Internet, one or more local area networks (LANs), one or more wide area networks (WANs), wire-line type connections, wireless type connections, cellular or any combination thereof. Likewise, sub-networks, which can employ different architectures or can be compliant or compatible with different protocols, can interoperate within a larger network.

For purposes of this disclosure, a “wireless network” should be understood to couple client devices with a network. A wireless network can employ stand-alone ad-hoc networks, mesh networks, Wireless LAN (WLAN) networks, cellular networks, or the like. A wireless network can further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies can enable wide area coverage for devices, such as client devices with varying degrees of mobility, for example.

In short, a wireless network can include virtually any type of wireless communication mechanism by which signals can be communicated between devices, such as a client device or a computing device, between or within a network, or the like.

A computing device can be capable of sending or receiving signals, such as via a wired or wireless network, or can be capable of processing or storing signals, such as in memory as physical memory states, and may, therefore, operate as a server. Thus, devices capable of operating as a server can include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device can include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device can vary in terms of capabilities or features. Claimed subject matter is intended to cover a wide range of potential variations, such as a web-enabled client device or previously mentioned devices can include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

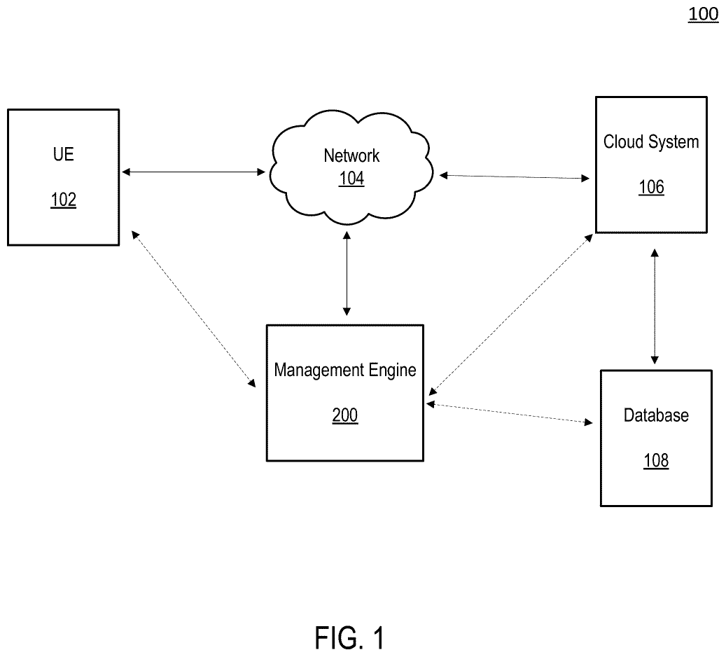

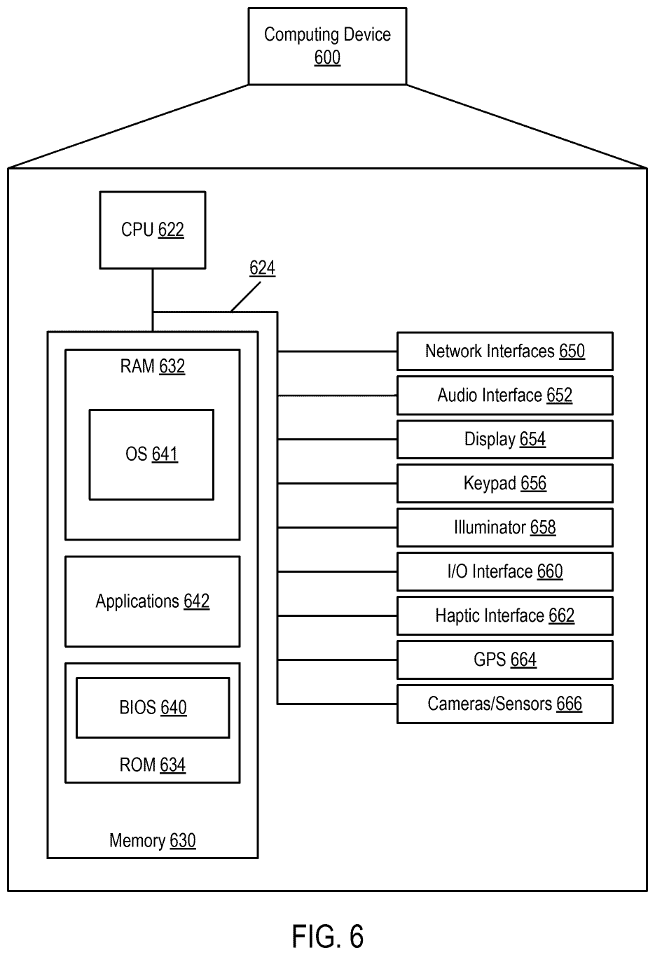

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 6), network 104, cloud system 106, database 108, and management engine 200. It should be understood that while system 100 is depicted as including such components, it should not be construed as limiting, as one of ordinary skill in the art would readily understand that varying numbers of UEs, peripheral devices, cloud systems, databases, network resources, engines and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, Internet of Things (IoT) device, autonomous machine, and any other device equipped with a cellular or wireless or wired transceiver.

In some embodiments, a peripheral device (not shown) can be connected to UE 102, and can be any type of peripheral device, such as, but not limited to, a wearable device (e.g., smart watch), printer, speaker, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 can be any type of cloud operating platform and/or network based system upon which applications, operations, and/or other forms of network resources can be located. For example, system 106 can be a service provider and/or network provider from where services and/or applications can be accessed, sourced or executed from. For example, system 106 can represent the cloud-based architecture associated with a network and/or electronic platform (e.g., Yahoo! Mail®, for example), which has associated network resources hosted on the internet or private network (e.g., network 104), which enables (via engine 200) the tagging and search functionality and capabilities discussed herein.

In some embodiments, cloud system 106 can include a server(s) and/or a database of information which is accessible over network 104. In some embodiments, a database 108 of cloud system 106 can store a dataset of data and metadata associated with local and/or network information related to a user(s) of the components of system 100 and/or each of the components of system 100 (e.g., UE, and the services and applications provided by cloud system 106 and/or management engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

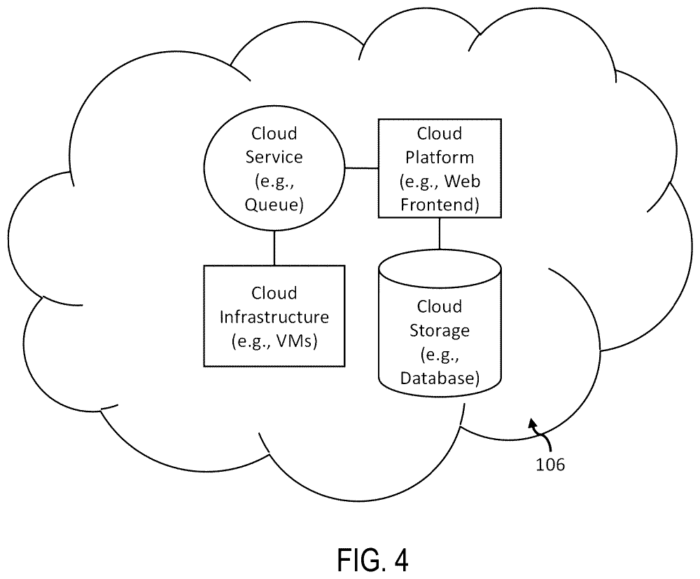

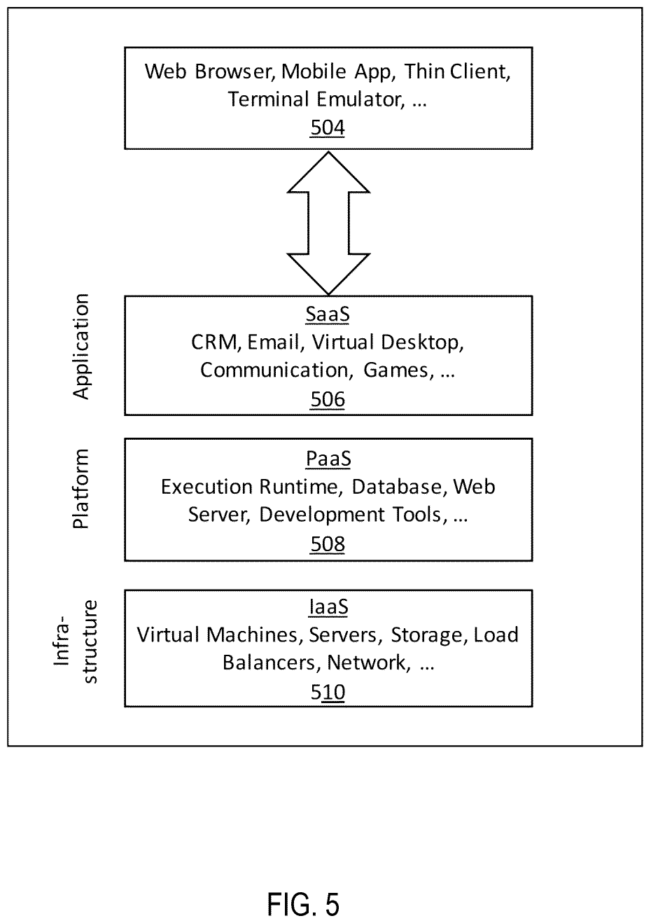

Turning to FIG. 4 and FIG. 5, in some embodiments, the exemplary computer-based systems/platforms, the exemplary computer-based devices, and/or the exemplary computer-based components of the present disclosure can be specifically configured to operate in a cloud computing/architecture 106 such as, but not limiting to: infrastructure as a service (IaaS) 510, platform as a service (PaaS) 508, and/or software as a service (SaaS) 506 using a web browser, mobile app, thin client, terminal emulator or other endpoint 504. FIG. 4 and FIG. 5 illustrate schematics of non-limiting implementations of the cloud computing/architecture(s) in which the exemplary computer-based systems for administrative customizations and control of network-hosted application program interfaces (APIs) of the present disclosure can be specifically configured to operate.

Turning back to FIG. 1, according to some embodiments, database 108 can correspond to a data storage for a platform (e.g., a network hosted platform, such as cloud system 106, as discussed supra) or a plurality of platforms. Database 108 can receive storage instructions/requests from, for example, engine 200 (and associated microservices), which can be in any type of known or to be known format, such as, for example, standard query language (SQL). According to some embodiments, database 108 can correspond to any type of known or to be known storage, for example, a memory or memory stack of a device, a distributed ledger of a distributed network (e.g., blockchain, for example), a look-up table (LUT), and/or any other type of secure data repository.

Management engine 200, as discussed above and further below in more detail, can include components for the disclosed functionality. According to some embodiments, management engine 200 can be a special purpose machine or processor, and can be hosted by a device on network 104, within cloud system 106, and/or on UE 102. In some embodiments, engine 200 can be hosted by a server and/or set of servers associated with cloud system 106.

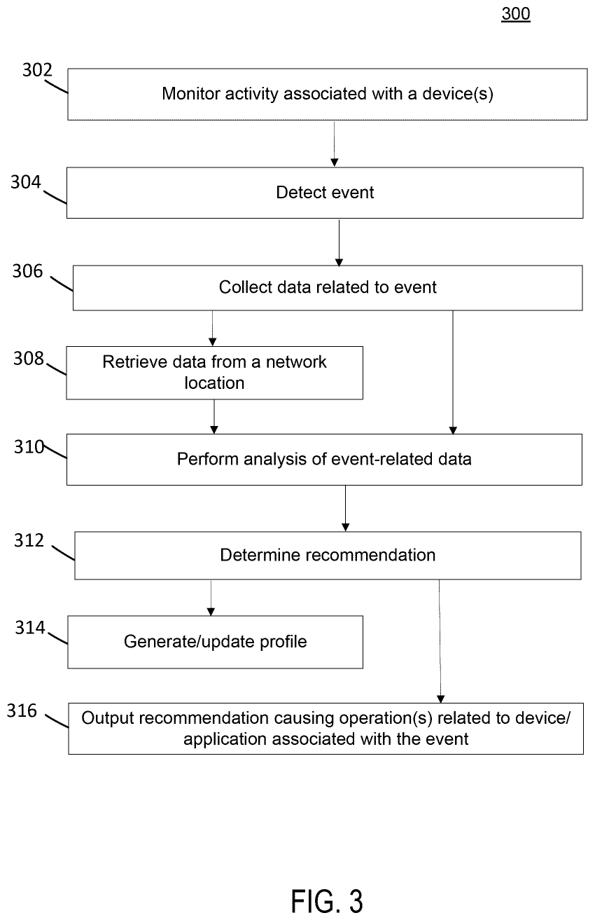

According to some embodiments, as discussed in more detail below, management engine 200 can be configured to implement and/or control a plurality of services and/or microservices, where each of the plurality of services/microservices are configured to execute a plurality of workflows associated with performing the disclosed search functionality. Non-limiting embodiments of such workflows are provided below in relation to at least FIG. 3.

According to some embodiments, as discussed above, management engine 200 can function as an application provided by cloud system 106. In some embodiments, engine 200 can function as an application installed on a server(s), network location and/or other type of network resource associated with system 106. In some embodiments, engine 200 can function as an application installed and/or executing on UE 102. In some embodiments, such application can be a web-based application accessed by UE 102 over network 104 from cloud system 106. In some embodiments, engine 200 can be configured and/or installed as an augmenting script, program or application (e.g., a plug-in or extension) to another application or program provided by cloud system 106 and/or executing on UE 102.

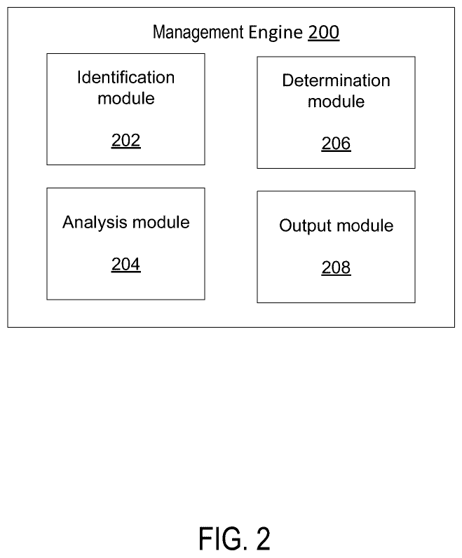

As illustrated in FIG. 2, according to some embodiments, management engine 200 includes identification module 202, analysis module 204, determination module 206 and output module 206. It should be understood that the engine(s) and modules discussed herein are non-exhaustive, as additional or fewer engines and/or modules (or sub-modules) can be applicable to the embodiments of the systems and methods discussed. More detail of the operations, configurations and functionalities of engine 200 and each of its modules, and their role within embodiments of the present disclosure will be discussed below.

According to some embodiments, management engine 200 or other device(s) running Process 300 can be operated entirely at the user device level, or with cloud support as a distributed system, or at a mail service provider's infrastructure, as non-limiting implementation examples. It will be understood that the disclosure herein provides for a configuration that is platform agnostic and can be operated on multiple alternative platforms as a matter of design choice using the teachings described.

Turning to FIG. 3, Process 300 provides non-limiting example embodiments for a DI-based computerized framework for on-device profiling and digital resource control, management and rendering based therefrom. As discussed in more detail below, the framework leverages on-device executed LLMs to provide user profiling functionality, such that operational events occurring at the device-level can be curated, generated, modified and/or recommended, whereby applications, device operations or some combination thereof, can be executed in accordance with recommendations generated from and aligned with the user profiling.

According to some embodiments, Steps 302-308 of Process 300 can be performed by identification module 202 of management engine 200; Step 310 can be performed by analysis module 204; Step 312 can be performed by determination module 206; and Steps 314 and 316 can be performed by output module 208.

According to some embodiments, Process 300 begins with Step 302 where engine 200 can perform monitoring of user activity across the device ecosystem, which can include monitoring device activity, user activity, application activity for a user, for an account, for a location, and the like, or some combination thereof. For example, the monitoring can involve detecting a received message within a user account of a mail application on the user's device. Such monitoring can be performed continuously and/or periodically (e.g., according to a time, date, criteria (e.g., event type), an application type, device type, user type, account type, and the like, or some combination thereof).

In some embodiments, such monitoring functionality can operate as a background service that captures interaction events across multiple application domains while implementing resource-efficient observation mechanisms. Such functionality leverages the device's event management subsystem to register listeners for relevant user interactions, including application launches, content consumption patterns, gesture interactions, dwell time metrics, and explicit preference selections. Such event listeners are configured with optimized triggering thresholds to minimize computational overhead while ensuring comprehensive data collection. Such monitoring component can implement adaptive sampling rates that dynamically adjust based on device resource availability, battery status, and detected usage patterns.

In some embodiments, during periods of intensive device usage or limited battery capacity, the sampling frequency can be automatically reduced to preserve system resources while maintaining statistically significant observation coverage. Conversely, in some embodiments, during periods of charging or idle device states with available computational capacity, the monitoring component can increase sampling density to capture more nuanced interaction patterns. Such monitoring functionality operates within a sandboxed execution environment that enforces strict data access controls, ensuring that only permissioned interaction data is captured and preventing access to sensitive personal information outside the framework's authorization scope.

In Step 304, engine 200 can detect, based on the monitoring, an event. In some embodiments, the event detection mechanisms can implement a multi-layered filtering architecture that efficiently identifies relevant user interactions while discarding noise events. This technical component incorporates both deterministic rule-based filters and probabilistic relevance assessment algorithms to maximize detection accuracy while minimizing false positives. For example, when monitoring email application usage, the event detection subsystem can identify significant events such as message receipt, message deletion without reading, explicit spam classification, reply actions, or content forwarding behaviors.

In some embodiments, each detected event can be assigned a relevance score through a (e.g., lightweight) machine learning (ML) classifier that evaluates the potential information value for user profiling purposes. Such relevance assessment considers factors, such as, for example, interaction frequency, deviation from established behavioral patterns, contextual indicators, and temporal relationships with other observed events. In some embodiments, such event detection can function to maintain a sliding window of recent user interactions to establish behavioral baselines, enabling the identification of statistically significant deviations that may indicate preference shifts or emergent behavioral patterns. When events exceed the configurable relevance threshold, they trigger subsequent processing steps within the workflow.

In Step 306, engine 200 can, based upon the event detection, activate data collection operations to determine comprehensive contextual information related to the identified event. In some embodiments, engine 200 can identify and assemble relevant contextual signals into a coherent representation suitable for LLM analysis. The data collection operations can access multiple on-device data sources through standardized application program interfaces (APIs), including application-specific event logs, interaction timestamps, content metadata, environmental contexts, and device state information.

By way of non-limiting example, in some embodiments, when collecting data related to an email receipt event, engine 200 can capture sender information, subject line content, message timestamp, device location context, current application state, and recent interaction history. The collected data can be structured according to a standardized schema optimized for LLM processing, with explicit type annotations and relationship indicators to enhance semantic understanding. This schema implementation ensures that collected data maintains consistent representation formats regardless of the originating application context, enabling the LLM to generalize effectively across multiple domains.

In some embodiments, the data collection operations can implement privacy-preserving transformations that remove or obfuscate potentially sensitive information before storage, including personal identifiers, location coordinates, or explicit content details. These transformations apply differential privacy techniques with configurable privacy budgets to maintain analytical utility while preventing potential re-identification.

In some embodiments, when additional context from server resources is determined to enhance the analysis quality (as per a context of the event and/or according to a preference or setting, for example), engine 200 can proceed from Step 306 to Step 308, then to Step 310. In some embodiments, Step 308 can be skipped.

In some embodiments, Step 308's operations can involve utilizing secure communication channels with authenticated backend services to retrieve relevant historical or aggregated data, which can be related to the user, event, device, application, and the like, or some combination thereof. According to some embodiments, the server data retrieval process can utilize cryptographic protocols for such communications, implementing end-to-end (E2E) encryption with perfect forward secrecy to prevent unauthorized data access during transmission. When requesting server data, engine 200 can transmit minimal query parameters necessary for relevant data retrieval, avoiding unnecessary disclosure of user-specific information.

For example, when processing an email event, engine 200 can request historical interaction statistics related to similar message types or sender domains, aggregated across the user population to identify common response patterns. These server requests implement strict rate limiting and data minimization principles, retrieving only essential information elements while avoiding bulk data transfers. The retrieved server data undergoes local validation to ensure integrity and relevance before integration with the locally collected contextual information. This validation includes cryptographic signature verification, schema compliance checks, and temporal relevance assessment to prevent the utilization of outdated or potentially corrupted information. Once validated, the server data is merged with the local context using standardized data fusion algorithms that maintain consistent representation formats for subsequent analysis.

In Step 310, engine 200 can perform analysis of the event-related data, which as discussed above, can be based on the collected data in Step 306, or based on the collected data in Step 306 and the data from Step 308, discussed supra.

In Step 310, engine 200 activates inference mechanisms to analyze local and/or server-sourced data and extract meaningful patterns, preferences, and behavioral indicators. Such implementation leverages optimized model architectures specifically designed for efficient execution within mobile device constraints, such as quantized transformer networks with reduced parameter counts or knowledge-distilled variants of larger models.

According to some embodiments, such operations of Step 310 can involve performing a context construction, involving assembling the collected data into a structured prompt optimized for the specific LLM deployment. This prompt engineering implements domain-specific templates that maximize information extraction while minimizing token consumption, incorporating explicit instructions that guide the model toward relevant analytical dimensions. For example, when analyzing email interaction patterns, the prompt can direct the model to focus on content category preferences, sender relationship indicators, response tendencies, and temporal engagement patterns. Such inference execution leverages available hardware acceleration through neural processing units or graphics processors when available, implementing dynamic computational graph optimizations that maximize parallel processing capabilities.

In some embodiments, for devices lacking specialized acceleration hardware, the inference component implements progressive tensor computation with intermediate checkpointing, minimizing memory requirements while maintaining analysis quality.

In some embodiments, Step 310's analysis processing can incorporate multi-pass interpretation, whereby initial inferential outputs can undergo refinement through subsequent model queries with increasingly focused analytical objectives, gradually building a comprehensive understanding of user preferences and behavioral patterns.

In some embodiments, such computational analysis in Step 310 can involve engine 200 calling and executing an AI and/or ML model and/or a LLM. Accordingly, in some embodiments, the AI/ML models can be any type of known or to be known, specifically trained AI/ML model, particular machine learning model architecture, particular machine learning model type (e.g., convolutional neural network (CNN), recurrent neural network (RNN), autoencoder, support vector machine (SVM), and the like), or any other suitable definition of an AI/ML model or any suitable combination thereof.

In some embodiments, an LLM can be leveraged, as discussed herein, whether known or to be known. As discussed above, an LLM is a type of AI system designed to understand and generate human-like text based on the input it receives. The LLM can implement technology that involves deep learning, training data and NLP. Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, such model can be configured to identify and utilize one or more AI/ML techniques selected from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique can be one of, without limitation, feedforward neural network, radial basis function network, recurrent neural network, convolutional network (e.g., U-net) or other suitable network. In some embodiments and, optionally, in combination with any embodiment described above or below, an implementation of the Neural Network can be executed as follows:
a. define Neural Network architecture/model,
b. transfer the input data to the neural network model,
c. train the model incrementally,
d. determine the accuracy for a specific number of timesteps,
e. apply the trained model to process the newly received input data,
f. optionally and in parallel, continue to train the trained model with a predetermined periodicity.

In some embodiments and, optionally, in combination of any embodiment described above or below, the trained neural network model can specify a neural network by at least a neural network topology, a series of activation functions, and connection weights. For example, the topology of a neural network can include a configuration of nodes of the neural network and connections between such nodes. In some embodiments and, optionally, in combination of any embodiment described above or below, the trained neural network model can also be specified to include other parameters, including but not limited to, bias values/functions and/or aggregation functions. For example, an activation function of a node can be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function can be a mathematical function that combines (e.g., sum, product, and the like) input signals to the node. In some embodiments and, optionally, in combination of any embodiment described above or below, an output of the aggregation function can be used as input to the activation function. In some embodiments and, optionally, in combination of any embodiment described above or below, the bias can be a constant value or function that can be used by the aggregation function and/or the activation function to make the node more or less likely to be activated.

In Step 312, based on the analysis from Step 310, engine 200 can function to determine a recommendation, as discussed herein. According to some embodiments, Step 312 involves transforming the raw analytical outputs from the LLM into structured recommendation data suitable for application integration and potential server synchronization. The recommendation generation process implements domain-specific decoders that translate the LLM's natural language outputs into structured data representations with explicit type annotations and confidence metrics. Such decoders incorporate validation logic that ensures recommendation consistency, identifying and resolving potential contradictions or ambiguities in the model's outputs.

For example, when processing email-related analyses, the component might generate structured recommendations regarding message categorization preferences, sender prioritization rules, content filtering parameters, or interface customization options. Each recommendation includes associated confidence scores derived from statistical analysis of the LLM's output distribution, enabling downstream components to implement appropriate threshold-based filtering.

In some embodiments, such recommendation data can undergo normalization operations to ensure consistent representation formats regardless of the specific analysis domain, facilitating integration across multiple application contexts. In parallel with local recommendation storage, engine 200 can determine anonymized analytical insights for potential server transmission, implementing privacy-preserving transformations that remove user-specific identifiers while preserving statistical utility. Such updates enable continuous improvement of network-level models through federated learning approaches, wherein individual device insights contribute to collective intelligence without exposing raw user data.

In Step 314, engine 20 can generate (or update, should a profile previously exist) a user preference profile. In some embodiments, Step 314 can involve compiling, updating and/or generating structured profile representation files in formats optimized for efficient storage, retrieval, and application integration.

In some embodiments, the profile generation process begins with schema validation of the incoming recommendation data, ensuring compliance with the framework's standardized profile structure. In some embodiments, for new users without existing profiles, engine 200 can initialize a comprehensive preference structure with default values and confidence intervals that reflect uncertainty in initial predictions. In some embodiments, for users with established profiles, engine 200 can implement, for example, Bayesian updating mechanisms that integrate new recommendations while considering prior confidence levels and temporal decay factors. Such mechanisms ensure that recent behavioral patterns receive appropriate weighting while maintaining consistency with established preferences.

According to some embodiments, the profile structure can implement hierarchical organization with explicit relationship modeling between preference domains, enabling cross-domain inference and transfer learning capabilities. For example, content preferences identified in email interactions might inform recommendations in other communication applications through explicit relationship mappings.

In some embodiments, the profile storage mechanism can implement differential encryption techniques, wherein highly sensitive preference indicators receive stronger protection than general behavioral patterns. Such tiered security approach optimizes the balance between computational overhead and privacy protection. Such profile synchronization mechanisms can enable optional cloud backup through encrypted channels, implementing conflict resolution protocols for scenarios where multiple devices contribute to a unified user profile.

And, in Step 316, engine 200 can perform operations to generate a recommendation that translates profile insights into tangible application (and/or device) behaviors. Such operations can implement standardized integration interfaces that enable diverse applications to consume the generated recommendations while maintaining consistent user experiences.

In some embodiments, such recommendation delivery process begins with context-aware filtering that selects relevant profile elements based on the current application state, user activity, and environmental factors. This filtering ensures that only contextually appropriate recommendations influence application behavior, preventing jarring experiential discontinuities. Engine 200 can implement integration modalities to accommodate diverse application architectures, including, but not limited to, callback registration, event broadcasting, direct API queries, and content provider interfaces.

For example, when providing recommendations to a search application, the component might expose personalized ranking factors that prioritize results aligned with the user's identified interests. For advertising systems, engine 200 can provide content affinity indicators that enable more relevant creative selection without exposing specific user attributes.

In some embodiments, such recommendation applications can implement progressive enhancement principles, wherein basic functionality remains available even when personalization data is limited or unavailable. This approach ensures consistent application performance across varying levels of profile completeness.

In some embodiments, engine 200 can implement feedback collection mechanisms that capture explicit or implicit user responses to applied recommendations, creating a closed feedback loop that enables continuous refinement of the profiling system's effectiveness, as well as the LLM utilized in Step 310, discussed supra.

According to some embodiments, as discussed above, the framework, via engine 200, can implement device and/or application optimization across all or at least a portion of the steps of Process 300 to ensure efficient execution within mobile device constraints. For example, such optimization includes adaptive scheduling mechanisms that distribute computational workloads during periods of device inactivity or charging states, minimizing impact on interactive performance. Indeed, in some embodiments, the framework can implement tiered processing modes that dynamically adjust analytical depth based on available resources, enabling graceful degradation on lower-capability devices while maximizing personalization on high-performance hardware.

According to some embodiments, runtime optimizations include, but are not limited to, tensor operation fusion, weight sharing across multiple analysis domains, and incremental computation with partial result caching to minimize redundant processing. In some embodiments, memory management techniques include, but are not limited to, model parameter compression through quantization and pruning, activation checkpointing during inference, and garbage collection optimization to minimize memory footprint. In some embodiments, power consumption optimizations include, but are not limited to, batch processing of multiple events when appropriate, dynamic clock scaling during computation, and cooperative scheduling with the device's power management subsystem.

In some embodiments, the framework can enhance Process 300 with explicit security controls that protect against potential exploitation or privacy compromise. These security measures include, but are not limited to, runtime integrity verification that validates the authenticity of model parameters and execution environments before processing sensitive user data. Accordingly, in some embodiments, access control mechanisms can enforce strict permission boundaries around profile data, preventing unauthorized applications from extracting personalized insights without explicit user consent. Anomaly detection components can monitor for unusual data access patterns or recommendation requests that might indicate potential security compromises, implementing automatic protective responses such as profile encryption or temporary functionality limitation. In some embodiments, regular/scheduled and/or dynamically determined security audits scan the framework's operation for potential vulnerabilities, implementing automatic updates to address identified risks without requiring manual intervention.

Accordingly, the disclosed framework provides functionality for leveraging on-device AI to enable personalized user experiences while maintaining privacy safeguards and efficient resource utilization. By distributing computational workloads to end-user devices and implementing comprehensive optimization strategies, the framework enables personalization capabilities previously feasible only through server-centric approaches with their associated privacy and scalability limitations. Such functionality ensures adaptive responsiveness to evolving user preferences while maintaining consistent performance across diverse device capabilities and application contexts.

FIG. 6 is a schematic diagram illustrating a client device showing an example embodiment of a client device that can be used within the present disclosure. Client device 600 can include many more or less components than those shown in FIG. 6. However, the components shown are sufficient to disclose an illustrative embodiment for implementing the present disclosure. Client device 600 can represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 can optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 can be a liquid crystal display (LCD), gas plasma, light emitting diode (LED), or any other type of display used with a computing device. Display 654 can also include a touch sensitive screen arranged to receive input from an object such as a stylus or a digit from a human hand.

Keypad 656 can include any input device arranged to receive input from a user. Illuminator 658 can provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 can through other components, provide other information that can be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores can be employed to store information that describes various capabilities of Client device 600. The information can then be provided to another device based on any of a variety of events, including being sent as part of a header (e.g., index file of the HLS stream) during a communication, sent upon request, or the like. At least a portion of the capability information can also be stored on a disk drive or other storage medium (not shown) within Client device 600.

Applications 642 can include computer executable instructions which, when executed by Client device 600, transmit, receive, and/or otherwise process audio, video, images, and enable telecommunication with a server and/or another user of another client device. Applications 642 can further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements can include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors can be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors can be dual-core processor(s), dual-core mobile processor(s), and so forth.

Computer-related systems, computer systems, and systems, as used herein, include any combination of hardware and software. Examples of software can include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements can vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module can be stored on a computer readable medium for execution by a processor. Modules can be integral to one or more servers, or be loaded and executed by one or more servers. One or more modules can be grouped into an engine or an application.

One or more aspects of at least one embodiment can be implemented by representative instructions stored on a machine-readable medium which represents various logic within the processor, which when read by a machine causes the machine to fabricate logic to perform the techniques described herein. Such representations, known as “IP cores,” can be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure can be downloadable from a network, for example, a website, as a stand-alone product or as an add-in package for installation in an existing software application. For example, exemplary software specifically programmed in accordance with one or more principles of the present disclosure can also be available as a client-server software application, or as a web-enabled software application. For example, exemplary software specifically programmed in accordance with one or more principles of the present disclosure can also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure can be implemented in many manners and as such are not to be limited by the foregoing exemplary embodiments and examples. In other words, functional elements being performed by single or multiple components, in various combinations of hardware and software or firmware, and individual functions, can be distributed among software applications at either the client level or server level or both. In this regard, any number of the features of the different embodiments described herein can be combined into single or multiple embodiments, and alternate embodiments having fewer than, or more than, all of the features described herein are possible.

Functionality can also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that can be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications can be made to the elements and operations described above to obtain a result that remains within the scope of the systems and processes described in this disclosure.

What is claimed is:

1. A method comprising:
detecting, by an application on a device, an event, the event corresponding to receipt of a message addressed to a user of the device, the message communicated to an account of the user;
analyzing, by the application, the event, and determining contextual data related to event;
analyzing, by the application, the contextual data, and determining a recommendation for responding to the event; and
causing, by the application, automatic operation of the recommendation upon detection of the event, the automatic operation comprising causing at least one of the application or device to function in a manner enabling performance of the recommendation.

2. The method of claim 1, further comprising:
generating a device-based profile based at least on the determined recommendation and the contextual data; and
updating the device-based profile upon detection of a subsequent event.

3. The method of claim 2, further comprising performing the analysis of the contextual data based on information within the device-based profile.

4. The method of claim 2, further comprising the device-based profile being stored on the device.

5. The method of claim 1, further comprising;
retrieving, over a network, additional data from a network location, the additional data being related to the event; and
performing the analysis of the contextual data based further on the additional data.

6. The method of claim 1, further comprising the application comprising functionality related to a large language model (LLM).

7. The method of claim 1, further comprising the recommendation comprising the contextual data corresponding to a type of activity predicted to be performed in response to the message, the type of activity forming a basis for the recommendation.

8. The method of claim 1, further comprising monitoring activity related to the account, and performing the detection of the event based on the monitoring.

9. A device comprising;
a processor configured to:
detect, by an application, an event, the event corresponding to receipt of a message addressed to a user of the device, the message communicated to an account of the user;
analyze, by the application, the event, and determining contextual data related to event;
analyze, by the application, the contextual data, and determining a recommendation for responding to the event; and
cause, by the application, automatic operation of the recommendation upon detection of the event, the automatic operation comprising causing at least one of the application or device to function in a manner enabling performance of the recommendation.

10. The device of claim 9, wherein the processor is further configured to:
generate a device-based profile based at least on the determined recommendation and the contextual data; and
update the device-based profile upon detection of a subsequent event.

11. The device of claim 10, wherein the processor is further configured to perform the analysis of the contextual data based on information within the device-based profile.

12. The device of claim 10, wherein the processor is further configured such that the device-based profile is stored on the device.

13. The device of claim 9, wherein the processor is further configured to;
retrieve, over a network, additional data from a network location, the additional data being related to the event; and
perform the analysis of the contextual data based further on the additional data.

14. The device of claim 9, wherein the processor is further configured such that the application comprises functionality related to a large language model (LLM).

15. The device of claim 9, wherein the processor is further configured such that the recommendation comprises the contextual data corresponding to a type of activity predicted to be performed in response to the message, the type of activity forming a basis for the recommendation.

16. The device of claim 9, wherein the processor is further configured to monitoring activity related to the account, and performing the detection of the event based on the monitoring.

17. A non-transitory computer-readable storage medium tangibly encoded with computer-executable instructions, that when executed by a processor, perform a method comprising:
detecting, by an application on a device, an event, the event corresponding to receipt of a message addressed to a user of the device, the message communicated to an account of the user;
analyzing, by the application, the event, and determining contextual data related to event;
analyzing, by the application, the contextual data, and determining a recommendation for responding to the event; and
causing, by the application, automatic operation of the recommendation upon detection of the event, the automatic operation comprising causing at least one of the application or device to function in a manner enabling performance of the recommendation.

18. The non-transitory computer-readable storage medium of claim 17, further comprising:
generating a device-based profile based at least on the determined recommendation and the contextual data, the device-based profile being stored on the device; and
updating the device-based profile upon detection of a subsequent event.

19. The non-transitory computer-readable storage medium of claim 18, further comprising performing the analysis of the contextual data based on information within the device-based profile.

20. The non-transitory computer-readable storage medium of claim 17, further comprising;
retrieving, over a network, additional data from a network location, the additional data being related to the event; and
performing the analysis of the contextual data based further on the additional data.
